(19) United States
(12) Patent Application Publication
(10) Pub. No.: US 2004/0203814 A1
(43) Pub. Date: Oct. 14, 2004

(54) Method of allocating channels to base stations in a telecommunications network, and a telecommunications network

(76) Inventors: Lester Tse Wee Ho, London (GB); Jonathan Michael Pitts, London (GB); Louis Gwyn Samuel, Swindon (GB)

Correspondence Address: Docket Administrator (Room 3J-219), Lucent Technologies Inc., 101 Crawfords Corner Road, Holmdel, NJ, 07733-3030, US

(21) Appl. No.: 10/382,445

(22) Filed: Mar. 6, 2003

(30) Foreign Application Priority Data
Mar. 6, 2002 (GB) 0205283.5
Jun. 24, 2002 (EP) 02254382.1

(51) Int. Cl. H04Q 7/20

(52) U.S. Cl. 455/450; 455/453; 455/67.11; 455/452.1

(57) ABSTRACT

Channels are allocated to base stations in a telecommunications network for communications with mobile user terminals. Interference is measured on each channel used by a respective base station. The measured interference value for that channel and base station is added to an interference record. Channels are allocated to the base stations for further communications dependent upon the recorded interference.

### CROSS REFERENCE TO RELATED APPLICATION

This application claims priority of European Application No. 02254382.1, filed Jun. 24, 2002, and also Great Britain Provisional Application No. 0205283.5, filed Mar. 6, 2002.

### TECHNICAL FIELD

The present invention relates to allocating channels to base stations in a telecommunications network for communications with mobile user terminals, and a telecommunications network comprising base stations for communications with mobile user terminals,

### BACKGROUND OF THE INVENTION

In cellular radio networks using frequency division multiple access methods, each mobile communicates with a fixed base station via a radio channel. Network operators are allocated a limited number of radio channels to use, which restricts the number of mobiles that can be operative. In order to increase the number of mobiles that can be used, network operators rely on intelligent allocation and reuse of channels throughout a coverage region. The reuse of channels, however, gives rise to the problem of co-channel interference, which is the interference caused by other mobiles using the same channel. Because of this, the allocation of the channels is made in such a way so that the mobiles using the same channel must be separated from one another by sufficient distances that the interference levels are kept within tolerable levels. The challenge of meeting the users' demands on the network whilst keeping the interference levels acceptable is made more difficult by the dynamic nature of the demand. Unexpected fluctuations of demand at different times of the day can make fixed channel allocation plans give an unacceptable quality of service, making the use of dynamic channel allocation more attractive.

A centralized dynamic channel allocation scheme called Maximum Packing (MP) was proposed in Everitt, D.; Manfield, D., “Performance analysis of cellular mobile communication systems with dynamic channel assignment” Selected Areas in Communications, IEEE Journal on, vol.7, no.8, October 1989 pp: 1172-1180, and a scheme called Compact Pattern Based Dynamic Channel Assignment (CP-based DCA) is presented in Yeung, K. L, Yum, T.-S. P, “Compact pattern based dynamic channel assignment for cellular mobile systems” Vehicular Technology, IEEE Transactions on, vol. 43 no. 4, November 1994 pp. 892-896. The centralized dynamic channel allocation schemes require system-wide information and the complexity of searching all the possible reallocations is difficult computationally. While Compact Pattern Based Dynamic Channel Assignment (CP-based DCA) scheme reduces the search complexity and limits the number of channel reassignments compared with other centralized schemes, it still has a high-centralized overhead.

The increasing complexity and size of telecommunications networks today have resulted in the shift from centralized control towards the use of distributed self-organizing systems in networks. This approach has made networks more robust, scalable and rapidly deployed. These self-organizing systems rely on the behaviour of its individual components to result in a useful overall global behavior, which is sometimes difficult to quantify and evaluate. Distributed channel allocation schemes are presented in I, C-L, Chao, P. H., “Local Packing-Distributed Dynamic Channel Allocation at Cellular Base Station,” IEEE GLOBECOM 1993, and Y. Furuya, Y. Akaiwa, “Channel segregation, a distributed adaptive channel allocation scheme for mobile communication-systems”, IEICE Trans. Commun. Electron. Inform. Syst., vol.74, no.6, pp.1531-1537, 1991.

As identified in Grover W. D., “Self-organizing Broad-Band Transport Networks”, Proceedings of the IEEE, volume 85, no. 10, pp. 1582-1611, October 1997, the ability of self-organization is a characteristic that telecommunications systems increasingly require as the need for scalable and robust networks increases. This has prompted the approach of a more distributed form of control in networks, and it has been an approach whose success can be seen in the rapid growth of the Internet. Another effort to implement a self-organizing system in telecommunications is in the field of wireless networks. Work has been going on to develop self-organizing, self-healing “ad-hoc” wireless networks where every node in such a system has sufficient intelligence to continuously sense and discover nearby nodes. Each node can dynamically determine the optimal path for forwarding data packets from itself hop by hop through the network to any other node in the network, and nodes can reconfigure themselves to heal any ruptures in the network.

Wireless ad-hoc networks are examples of self-organizing systems, and possess several characteristics that are common to other self-organizing systems. Self organizing systems all work on the basis of some form of organization or coordination on a system-wide (global) scale that arises due to the effects of the collective behavior of the individual parts of the system, or its sub-systems. This global behavior, also known as emergent behavior, is not something that occurs because it is dictated by a single controlling entity, but because of the simple interactions between the sub-systems. An example of emergent behavior in a self-organizing system is the ability of the trading markets, where the price of a product will go through adjustments to eventually find the true value of the commodity. It is, however, difficult to predict the behavior of such systems particularly if they are large and exposed to many different outside influences.

One such characteristic behavior is the occurrence of self-organized criticality. Systems that are heavily loaded are observed to be prone to catastrophic failure when even slight perturbations are applied; for example, entire road networks that are operating at or near capacity can be easily knocked out due to a failure or delay in one small part of the network. Such criticality has also been observed in computer networks, as described in Huberman B. A., Lukose R. M., “Social Dilemmas and Internet Congestion”, Science, vol 277, pp. 535-537, July 1997, and in Ohira T., Sawatari R., “Phase Transition in Computer Network Traffic Model”, Physical Review E, vol. 58, 1998.

### SUMMARY OF THE INVENTION

An embodiment of the present invention provides a method of allocating channels to base stations in a telecommunications network for communications with mobile user terminals. The method comprises measuring interference on each channel used by a respective base station, adding the measured interference value for that channel and base station to an interference record, and allocating channels to the base stations for further communications dependent upon the recorded interference.

The described embodiment relates to a self-organizing channel allocation scheme for a wireless network; more specifically a decentralized self-organizing channel allocation method for a cellular wireless network. More specifically, this involves a distributed dynamic frequency channel allocation scheme for a wireless network using measures of normalized accumulated interference at each base station. This has advantages of scalability; because the control is localized and distributed, the algorithm is able to handle a large network. This also has advantages of flexibility; the addition and removal of base stations in the network would not require any changes to the configuration of the other base stations in the network. This also has advantages of robustness; the decentralized nature of the algorithm enables the algorithm to function even if parts of the network fail.

In the described embodiment, the interference record is a matrix of total measured interference for each channel and base station combination used. The matrix αⱼₖ, contains the total measured interference when a base station j uses a channel k, and follows αⱼₖₜ=αⱼₖ₍ₜ₋₁₎+Iⱼₖₜ where αⱼₖₜ is the matrix αⱼₖ at time t, αⱼₖ₍ₜ₋₁₎ is the matrix αⱼₖ at earlier time t−1, and Iⱼₖₜ is the interference experienced by the base station j on the channel k at time t.

In this embodiment, the communications are call connections. For call connection with a mobile user terminal, the base station having that mobile user terminal in its cell is allocated the channel having the lowest recorded total interference among those channels available to the base station.

The present invention also provides a telecommunications network comprising base stations for communications with mobile user terminals, the base stations being operative to measuring interference on each channel they use, and the network further comprising a base station controller connected to the base stations and operative to record the measured interference values for each channel and base station combination used in an interference record and to allocate channels to the base stations for further communications dependent upon the recorded interference.

In this network, the interference record is a matrix of total measured interference for each channel and base station combination used. The matrix αⱼₖ, contains the total measured interference when a base station j uses a channel k, and follows αⱼₖₜ=αⱼₖ₍ₜ₋₁₎+Iⱼₖₜ where αⱼₖₜ is the matrix αⱼₖ at time t, αⱼₖ(t−1) is the matrix αⱼₖ at earlier time t−1, and Iⱼₖₜ is the interference experienced by the base station j on the channel k at time t.

In the described embodiment, the communications are call connections. For call-connection with a mobile user terminal, the base station having that mobile user terminal in its cell is allocated by the base station controller the channel having the lowest recorded total interference among those channels available to the base station.

Furthermore, the network may be a radio telecommunications network at least substantially in accordance with Universal Mobile Telecommunications System UMTS standards. In such a network, the channels are frequency channels. Each channel can be a (frequency-offset) uplink and downlink frequency pair.

### BRIEF DESCRIPTION OF THE DRAWINGS

FIG. 1 is a diagram illustrating a mobile telecommunications network (showing one base station for simplicity), and

FIG. 2 is a diagram illustrating results of simulations (performance comparison between random channel allocations and channel allocations according to the preferred method).

### DETAILED DESCRIPTION

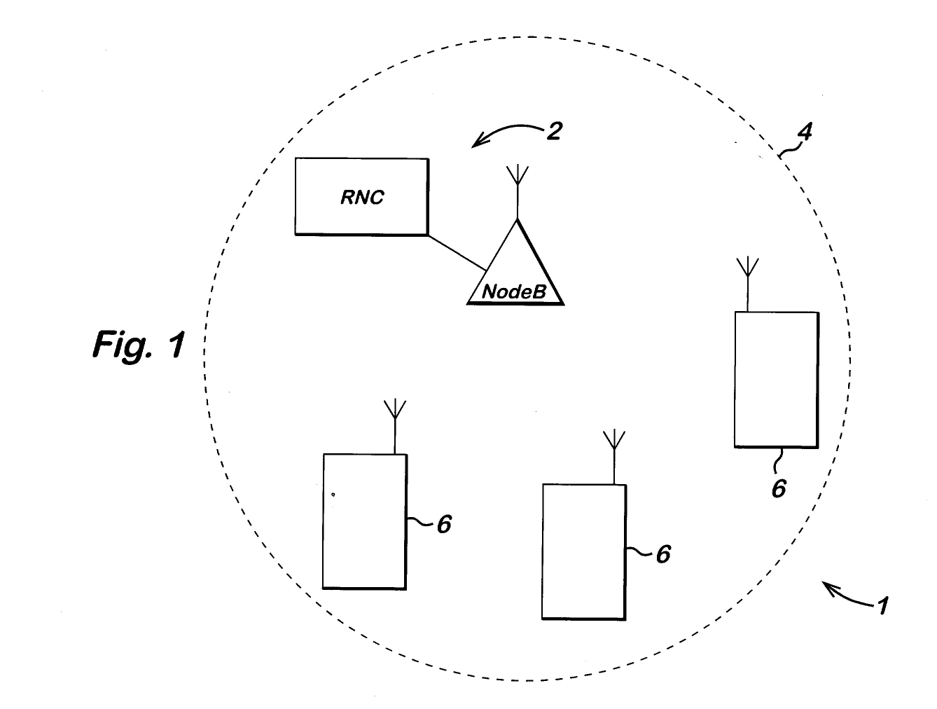

As shown in FIG. 1, a mobile telecommunications network 1 includes base stations 2 (one of which is shown in FIG. 1). In a Universal Mobile Telecommunications System UMTS network, the base station consists of a base transmitter-receiver station (NodeB in UMTS terminology) under the control of a so-called radio network controller RNC. Each base station 2 has an associated cell (i.e. area of coverage) in which it communicates with mobile user terminals 6. For each mobile user terminal 6 in call-connection with the base station 2, a channel is allocated for downlink communication (i.e. from base station to mobile user terminal), and a channel is allocated for uplink communication (i.e. from mobile user terminal to base station).

The method works by allocating the channels based on the accumulated interference experienced by the cells to produce an allocation plan that reduces the amount of interference. In order to do this, a matrix recording the accumulated interference is built up. Each element in the matrix, αⱼₖₜ contains the accumulated interference experienced when cell j uses channel k. The record of the accumulated interference is built up by updating the matrix over time according to:

αⱼₖₜ=αⱼₖ₍ₜ₋₁₎+I ⱼₖₜ

where Iⱼₖₜ is the interference experienced by cell j at channel k at time t, i.e. the co-channel interference at cell j caused by other cells (or mobiles) using the same channel k. (The co-channel interference fluctuates randomly in a normal distribution.).

During initialization, the accumulated interference matrix α is set to zero, and initially the channels are allocated randomly. The interference matrix, I, is generated based on the current channel allocation and the values for α are updated. At the next time step after initialization, a new channel allocation plan is now created not randomly but based on the accumulated interference. The channels are allocated to a cell starting from the one having the lowest accumulated interference, to the one with the highest, until the demand for channels in that cell is met. The steps of updating the accumulated interference matrix continue.

The matrix showing the various accumulated interference values for each frequency channel available to a base station can thus be considered as a priority list such that the channels are allocated so that the least amount of co-channel interference is obtained. The principle behind this is that there is a tendency towards producing a channel allocation plan that results in low interference once the accumulated interference matrix is built up sufficiently. The method is self learning in that it will initially try most or even all channel-cell pairings but eventually settle down to the best channel-cell pairings available. The method is able to cope with the dynamic nature of the network due to the fluctuations that are present in the signal interference, thus preventing the network from being stuck at one channel allocation once the network's conditions have changed.

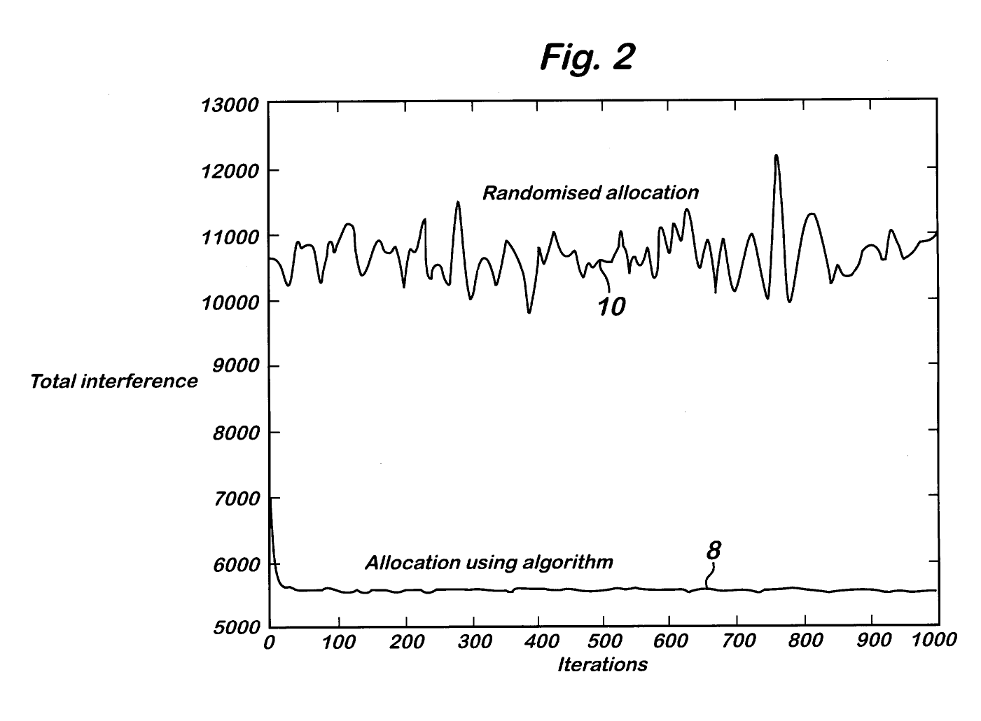

By running a simulation model, results obtained showed that the method is able to find a channel allocation solution which reduces the interference in the network. In the simulation, 64 base stations were considered to be placed in an 8×8 grid, and 29 frequency channels were available to be shared among the base stations. The results which are shown in FIG. 2 show how the accumulated interference 8 experienced by all the cells in the network decreased over time using the proposed method (as compared with the total interference 10 when a random channel allocation was used).

The above-described embodiments are illustrative of the principles of the present invention. Other embodiments may be devised by those skilled in the art without departing from the spirit and scope of the invention.

1. A method of allocating channels to base stations in a telecommunications network for communications with mobile user terminals, the method comprising:
measuring interference on each channel used by a respective base station,
adding the measured interference value for that channel and base station to an interference record, and
allocating channels to the base stations for further communications dependent upon the recorded interference.

2. The method according to claim 1, wherein the interference record is a matrix of total measured interference for each channel and base station combination used.

3. The method according to claim 2, wherein the matrix αⱼₖ, contains the total measured interference when a base station j uses a channel k, and follows αⱼₖ=αⱼₖ₍ₜ₋₁₎+Iⱼₖₜ where αⱼₖₜ is the matrix αⱼₖ at time t, αⱼₖ₍ₜ₋₁₎ is the matrix αⱼₖ at earlier time t−1, and Iⱼₖₜ is the interference measured by the base station j on the channel k at time t.

4. The method according to claim 1, wherein the communications are call connections.

5. The method according to claim 4, wherein for call connection with a mobile user terminal, the base station having that mobile user terminal in its cell is allocated the channel having the lowest recorded total interference among those channels available to the base station.

6. A telecommunications network comprising base stations for communications with mobile user terminals, the base stations being operative to measuring interference on each channel they use, and the network further comprising a base station controller connected to the base stations and operative to record the measured interference values for each channel and base station combination used in an interference record and to allocate channels to the base stations for further communications dependent upon the recorded interference.

7. A network according to claim 6, wherein the interference record is a matrix of total measured interference for each channel and base station combination used.

8. The network according to claim 7, wherein the matrix αⱼₖ, contains the total measured interference when a base station j uses a channel k, and follows αⱼₖₜ=αⱼₖ₍ₜ₋₁₎+Iⱼₖₜ where αⱼₖₜ is the matrix αⱼₖ at time t, αⱼₖ₍ₜ₋₁₎ is the matrix αⱼₖ at earlier time t−1, and Iⱼₖₜ is the interference experienced by the base station j on the channel k at time t.

9. The network according to claim 6, wherein said communications are call connections.

10. The network according to claim 9, wherein for a call-connection with a mobile user terminal, the base station having that mobile user terminal in its cell is allocated by the base station controller the channel having the lowest recorded total interference among those channels available to the base station.
